(19) United States
(12) Patent Application Publication
(10) Pub. No.: US 2018/0038280 A1
(43) Pub. Date: Feb. 8, 2018

(54) TURBOMACHINE COMPRISING A HEAT MANAGEMENT SYSTEM

(71) Applicant: AIRBUS OPERATIONS (SAS), Toulouse (FR)

(72) Inventors: Jean-Michel ROGERO, Toulouse (FR); Olivier VERSEUX, Tournefeuille (FR)

(21) Appl. No.: 15/667,873

(22) Filed: Aug. 3, 2017

(30) Foreign Application Priority Data
Aug. 3, 2016 (FR) 1657541

(51) Int. Cl. F02C 7/14; F02C 3/04; F02C 7/22; B64D 15/02; F02C 6/04; B64D 27/10; B64D 33/02; F01D 25/24; F02C 7/047

(52) U.S. Cl. CPC F02C 7/14; F01D 25/24; F02C 3/04; F02C 7/222; F02C 7/047; F02C 6/04; B64D 27/10; B64D 33/02; B64D 15/02; F05D 2260/213; F05D 2220/323

(57) ABSTRACT

A dual-flow turbomachine including a nacelle, compressors, turbines, a fuel supply line, a transfer line, a de-icing circuit, and a heat management system having: a first heat exchanger providing an exchange of heat between fuel in the supply line and oil in the transfer line, a loop comprising a main line and a pump which circulates a heat transfer fluid in the main line, where the main line is connected to an outlet of the pump and enters an inlet of a third heat exchanger, where at the outlet of the third heat exchanger the main line meets an inlet of the de-icing circuit, where at the outlet of the de-icing circuit the main line meets the inlet of the pump, and where the third heat exchanger transfers heat between the heat transfer fluid of the main line and the oil of the transfer line.

### RELATED APPLICATION

This application claims priority to French patent application 1657541 filed Aug. 3, 2016, the entirety of which is incorporated by reference.

### TECHNICAL FIELD

The present invention relates to an aircraft turbomachine comprising a heat management system, and particularly to an aircraft comprising at least one such turbomachine.

### PRIOR ART

FIG. 1 shows a turbomachine 10 of an aircraft. The turbomachine 10 is equipped with a heat management system 50 of the prior art. The heat management system 50 makes it possible to manage the heat energy of the propulsion unit comprising the turbomachine 10, the nacelle 11 and the other systems of the propulsion unit, taking excess heat in order to redistribute it to those systems which require heat in order to provide a function, by means of the circulation of a heat transfer fluid.

In particular, part of the heat energy is used to control the temperature of fluids (engine oil, electrical generator, hydraulic fluid, air-conditioning), structures (engine turbine, air intake lip and leading edge of the wings for anti-icing) and systems (valves, electronics, actuators, pumps etc.).

The majority of this portion of the heat energy is then lost for the engine thrust.

The turbomachine 10 comprises: a fan 12 designed to generate a flow of air in the turbomachine 10 in a direction of movement 13 of the air in the turbomachine 10, where, as is known, the flow of air then moves downstream from the fan 12; a set of compressors 14 downstream of the fan 12; a combustion chamber 16 downstream of the set of compressors 14, and a set of turbines 18 downstream of the combustion chamber 16.

The heat management system 50 generally comprises: a first heat exchanger 51; a second heat exchanger 52, and a third heat exchanger 53.

The heat management system 50 also comprises a hot air line 54 which takes hot air from the primary flow of the set of compressors 14 and transports it, for example, to the nacelle 11 in order to de-ice the latter. This air is expelled to the outside and is therefore lost.

The turbomachine 10 also comprises a supply line 55 which supplies the combustion chamber 16 with fuel.

The turbomachine 10 also comprises a transfer line 56 with which it is possible to circulate hot oil from the engine, in particular from the set of compressors 14, towards the first 51 and third 53 heat exchangers, and then back into the engine, in particular into the set of turbines 18.

The first heat exchanger 51 provides an exchange of heat between the fuel in the supply line 55 and the oil in the transfer line 56 in order to heat the fuel using the heat given off by the oil, and thus cool the latter.

The third heat exchanger 53 provides an exchange of heat between the oil in the transfer line 56 and the air in a first air line 57 which takes air from the secondary flow of the turbomachine 10 and discharges it to the outside or to the secondary flow. With this third heat exchanger 53 it is possible to complete the cooling of the oil.

The heat management system 50 also comprises an air-conditioning system 58 which takes air from the primary flow, generally at the intermediate and final stages of the set of compressors 14. To that end, the air-conditioning system 58 comprises a first line 59 which takes the air from the intermediate stage and a second line 60 which takes the air from the final stage. The first line 59 and second line 60 meet upstream of the second heat exchanger 52 and emerge from the second heat exchanger 52 to supply the air-conditioning system for the cabin of the aircraft.

The second heat exchanger 52 provides an exchange of heat between, on one hand, the air of the first line 59 and the second line 60 and, on the other hand, the air of a second air line 61 which takes air from the secondary flow of the turbomachine 10 and discharges it to the outside or to the secondary flow. With this second heat exchanger 52 it is possible to cool the air from the first line 59 and the second line 60.

Although such an installation is quite satisfactory, it does imply an increase in drag, and therefore higher fuel consumption.

### SUMMARY OF THE INVENTION

A turbomachine has been invented and is disclosed here having a heat management system with which it is possible to reduce drag, and which permits better management of the fluid flows in the turbomachine.

To that end, an embodiment of the invention is a dual-flow turbomachine for an aircraft, comprising a nacelle forming an air inlet lip, a set of compressors, a combustion chamber, a set of turbines, a supply line supplying fuel to the combustion chamber, a transfer line which circulates oil from the set of compressors to the set of turbines, a de-icing circuit for the air inlet lip, and a heat management system comprising:

(i) a first heat exchanger providing an exchange of heat between the fuel in the supply line and the oil in the transfer line,

(ii) a loop comprising a main line and a pump which is designed to circulate a heat transfer fluid in the main line, where the main line is connected to the outlet of the pump and enters an inlet of a third heat exchanger, where at the outlet of the third heat exchanger the main line meets an inlet of the de-icing circuit, where at the outlet of the de-icing circuit the main line meets the inlet of the pump, and where the third heat exchanger provides an exchange of heat between the heat transfer fluid of the main line and the oil of the transfer line leaving the first heat exchanger.

This particular arrangement permits better management of the anti-icing at the air intake lip.

Advantageously, the heat management system comprises:

(i) a first three-way valve arranged upstream of the inlet of the third heat exchanger and a first divert line arranged between the first valve and the main line, downstream of the outlet of the third heat exchanger, and/or

(ii) a second three-way valve arranged upstream of the inlet to the de-icing circuit and a second divert line arranged between the second valve and the main line, downstream of the outlet of the de-icing circuit.

The heat management system may further comprise a fourth heat exchanger arranged on the main line between the outlet of the de-icing circuit and the inlet of the pump, and the fourth heat exchanger provides an exchange of heat between the heat transfer fluid in the main line and the air of a first air line which takes air from the secondary flow of the turbomachine and discharges it to the outside or to the secondary flow.

The heat management system may further comprise a third three-way valve arranged upstream of the inlet of the fourth heat exchanger and a third divert line arranged between the third valve and the main line, downstream of the outlet of the fourth heat exchanger.

The heat management system may further comprise an air-conditioning system which takes air from the primary flow of the set of compressors, via a first and a second line which supply an air-conditioning system of the aircraft, a second heat exchanger providing an exchange of heat between, on one hand, the air of the first line and the second line and, on the other hand, the heat transfer fluid of the main line, and the second heat exchanger is arranged on the main line between the outlet of the third heat exchanger and the inlet of the de-icing circuit.

The heat management system may further comprise a fourth three-way valve arranged upstream of the inlet of the second heat exchanger and a fourth divert line arranged between the fourth valve and the main line, downstream of the outlet of the second heat exchanger.

The invention may be embodied in an aircraft comprising at least one turbomachine according to one of the preceding variants.

### BRIEF DESCRIPTION OF THE DRAWINGS

The features of the invention mentioned above, and others, will become clearer upon reading the following description of an exemplary embodiment, this description being provided in relation to the appended drawings in which:

FIG. 1 is a schematic representation of an aircraft turbomachine equipped with a prior art heat management system;

FIG. 2 is a side view of an aircraft comprising a turbomachine;

FIG. 3 is a schematic representation of an aircraft turbomachine equipped with a heat management system according to a first embodiment of the invention;

FIG. 4 is a schematic representation of an aircraft turbomachine equipped with a heat management system according to a second embodiment of the invention, and

FIG. 5 is a schematic representation of a controller which manages a heat management system according to the invention.

### DETAILED DISCLOSURE OF EMBODIMENTS

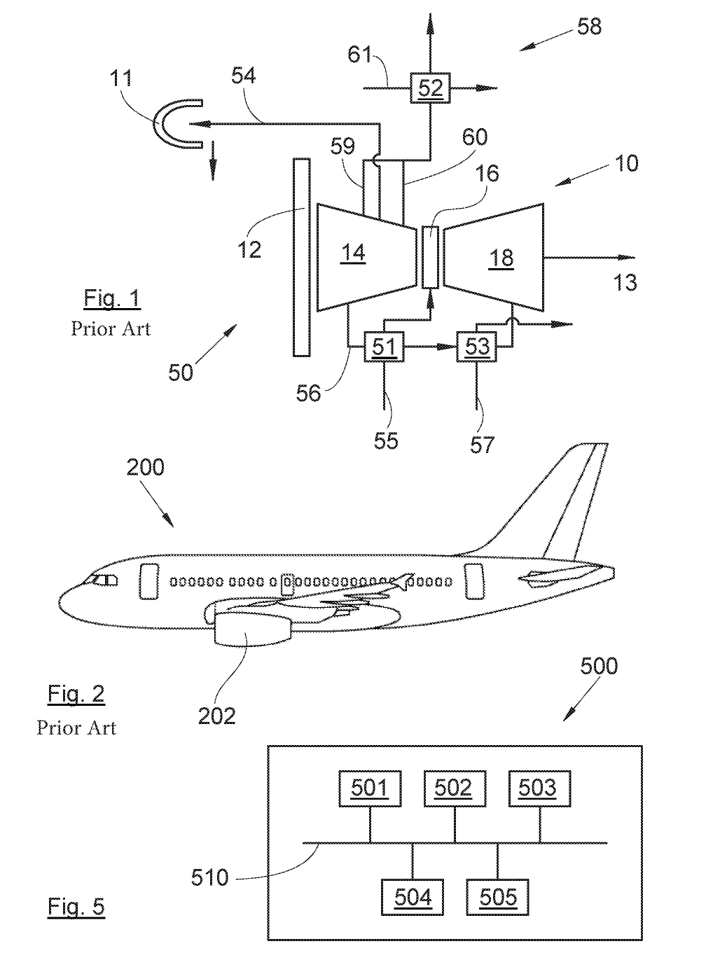

FIG. 2 shows an aircraft 200 equipped with a dual-flow turbomachine 202 according to the invention. The dual-flow turbomachine may be a turbofan including a fan and a gas turbine engine, e.g., jet engine.

FIG. 3 shows a turbomachine 30 equipped with a heat management system 300 according to a first embodiment of the invention, and FIG. 4 shows a turbomachine 40 equipped with a heat management system 400 according to a second embodiment of the invention. Each heat management system 300, 400 is intended to manage the distribution of heat between the various fluids in the turbomachine 30, 40.

The turbomachine 30, 40 comprises a nacelle 11 which forms, at the front, an air intake lip via which the air enters the turbomachine 30, 40. At the air intake lip, the nacelle 11 is equipped with a de-icing circuit 310, 410 for the air intake lip.

The turbomachine 30, 40 comprises elements in common with the turbomachine 1 of FIG. 1, in particular a gas turbine having a fan 12, a set of compressors 14, a combustion chamber 16, a set of turbines 18, a supply line 55 for supplying the fuel to the combustion chamber 16, a transfer line 56 for circulating hot oil from the set of compressors 14 to the set of turbines 18. These elements are provided with the same references. The fan 12 generates a flow of air in the turbomachine 30, 40 in a direction of movement 13 of the air in the turbomachine 30, 40.

Among the elements in common with the heat management system 50 of the prior art, the heat management system 300, 400 according to the invention comprises a first heat exchanger 51 which provides an exchange of heat between the fuel in the supply line 55 and the oil in the transfer line 56 in order to heat the fuel using the heat given off by the oil, and cool the latter.

The heat management system 300, 400 according to the invention comprises a loop 302, 402 in which circulates a heat transfer fluid.

The loop 302, 402 comprises a main line 306, 406 and a pump 304, 404 which is designed to circulate the heat transfer fluid in the main line 306, 406.

The main line 306, 406 is connected to the outlet of the pump 304, 404 and enters an inlet of a third heat exchanger 308, 408. On leaving the third heat exchanger 308, 408, the main line 306, 406 meets an inlet of the de-icing circuit 310, 410. At the outlet of the de-icing circuit 310, 410, the main line 306, 406 meets the inlet of the pump 304, 404.

The third heat exchanger 308, 408 provides an exchange of heat between the heat transfer fluid of the main line 306, 406 and the oil of the transfer line 56 leaving the first heat exchanger 51.

Thus, any heat of the engine oil transported in the transfer line 56 which has not been dissipated in the fuel of the supply line 55 is transferred to the heat transfer fluid of the loop 302, 402 via the third heat exchanger 308, 408. The heat transfer fluid heated in this manner then meets the de-icing circuit 310, 410 of the air intake lip, thus providing the de-icing function and allowing the heat transfer fluid to cool down.

A heat management system 300, 400 of this type distributes heat to those systems which need it, and the heat is not converted into another form of energy, making it possible to eliminate both the losses linked to that transformation and the mass of the associated systems. The heat management system 300, 400 minimizes wastage of ambient air which is drawn in by the engine but is not used for propulsion by limiting the number of air/air heat exchangers or air/fluid heat exchangers whose sole objective is to extract heat which is put to little or no use, and minimizes bleeding from the engine, and the anti-icing system, which is used only very sporadically, serves as a heat exchanger for regulating the temperature of the heat transfer fluid.

In order to compensate for the loss of efficacy of the heat exchanger constituted by the de-icing circuit 310, 410 of the air intake lip when the aircraft 200 is not moving or is at low speed, the heat management system 300, 400 comprises a fourth heat exchanger 312, 412 which is arranged on the main line 306, 406 between the outlet of the de-icing circuit 310, 410 and the inlet of the pump 304, 404.

The fourth heat exchanger 312, 412 provides an exchange of heat between the heat transfer fluid in the main line 306, 406 and the air of a first air line 314, 414 which takes air from the secondary flow of the turbomachine 30, 40 and discharges it to the outside or into the secondary flow.

The heat management system 300, 400 comprises an air-conditioning system 58 which takes air from the primary flow of the set of compressors 14, and it comprises, to that end, a first line 59 which takes the air from the intermediate stage of the set of compressors 14 and a second line 60 which takes the air from the final stage of the set of compressors 14. The first line 59 and second line 60 meet upstream of the second heat exchanger 52 and emerge from the second heat exchanger 52 to supply the air-conditioning system for the cabin of the aircraft.

In the first embodiment of the invention, shown in FIG. 3, the second heat exchanger 52 provides an exchange of heat between, on one hand, the air of the first line 59 and the second line 60 and, on the other hand, the air of a second air line 61 which takes air from the secondary flow of the turbomachine 20 and discharges it to the outside or to the secondary flow.

In the first embodiment of the invention, shown in FIG. 4, the second heat exchanger 52 provides an exchange of heat between, on one hand, the air of the first line 59 and the second line 60 and, on the other hand, the heat transfer fluid in the main line 406. The second heat exchanger 52 is arranged on the main line 406, between the outlet of the third heat exchanger 408 and the inlet of the de-icing circuit, 410. The second heat exchanger 52 is the pre-cooler for the air-conditioning system.

In order to best manage the heat management of the heat management system 300, 400, that is to say whether or not to use a certain element present along the main line 306, 406, the heat management system 300, 400 comprises divert lines which are hydraulically connected to the main line 306, 406, in parallel with said elements.

At the intersection between a divert line and the main line 306, 406, upstream of said element, there is arranged a remote-controlled three-way valve.

To that end, the heat management system 300, 400 comprises a controller 350, 450 which commands each three-way valve to open or to close individually depending on parameters of various sensors. The sensors are for example temperature sensors measuring the temperatures of the various fluids of the turbomachine 30, 40, or pressure sensors.

Thus, the heat management system 300, 400 permits dynamic and integrated management of the heat, avoiding heavy storage systems.

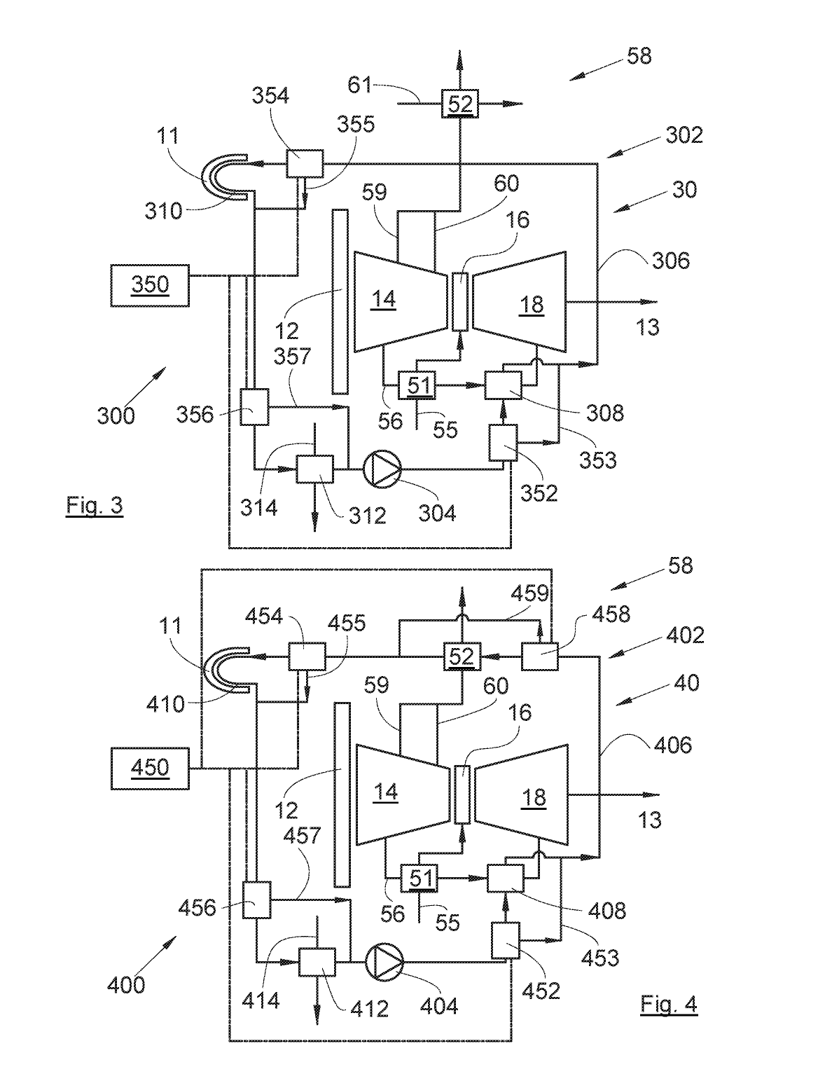

FIG. 5 shows a controller 500 which comprises, connected by a communication bus 510: a processor or CPU (“central processing unit”) 501, RAM (“random access memory”) 502, ROM (“read-only memory”) 503, a storage unit such as a hard disk or a storage support reader such as an SD (“secure digital”) card reader 504, and at least one communication interface 505 by means of which for example the controller 500 can communicate with the various three-way valves and the sensors.

The processor can execute instructions sent to the RAM from the ROM, from an external memory (not shown), from a storage support (such as an SD card), or from a communication network. When the equipment is energized, the processor is able to read instructions from the RAM and execute these.

The heat management system 300, 400 comprises at least one three-way valve and the following associated divert line:

for the first and second embodiments of the invention:

a first three-way valve 352, 452 arranged upstream of the inlet of the third heat exchanger 308, 408 and a first divert line 353, 453 arranged between the first valve 352, 452 and the main line 306, 406, downstream of the outlet of the third heat exchanger 308, 408, and/or

a second three-way valve 354, 454 arranged upstream of the inlet to the de-icing circuit 310, 410 and a second divert line 355, 455 arranged between the second valve 354, 454 and the main line 306, 406, downstream of the outlet of the de-icing circuit 310, 410, and/or

when the fourth heat exchanger 312, 412 is present:

a third three-way valve 356, 456 arranged upstream of the inlet of the fourth heat exchanger 312, 412 and a third divert line 357, 457 arranged between the third valve 356, 456 and the main line 306, 406, downstream of the outlet of the fourth heat exchanger 312, 412, and/or

for the second embodiment of the invention:

a fourth three-way valve 458 arranged upstream of the inlet of the second heat exchanger 52 and a fourth divert line 459 arranged between the fourth valve 458 and the main line 406, downstream of the outlet of the second heat exchanger 52.

An example of operation is described herein below.

The source of heat is in this case the engine oil which serves to lubricate the bearings of the engine and the gearbox.

The temperature of the engine oil must be kept around 100° C. where it enters the engine. The heat is extracted from the engine oil by the first heat exchanger 51 between the oil and the fuel. This first heat exchanger 51 is used as long as the outgoing fuel does not exceed a certain temperature, approximately 150° C. The residual excess heat is extracted from the engine oil by the third heat exchanger 308, 408 between the oil and the heat transfer fluid.

The heat transfer fluid heated in this manner passes some or all of its heat on to the air intake lip for anti-icing.

The heat exchangers are for example of the compact plate/fin or surface exchanger type.

In the second embodiment of the invention, the pre-cooler 52 of the air conditioning system 58 has been integrated into the loop 402, but it is possible to integrate heat exchangers of other systems of the aircraft 200, such as those for the electrical generators.

It is also possible to use the loop 302, 402 to control the temperature of the hydraulic fluid leaving the pump, by adding an exchanger between the hydraulic fluid and the heat transfer fluid of the loop 302, 402.

This loop 302, 402 can also be used to provide control of the turbine casings, by routing it around the casings.

Systems such as the air bleed valves can also be temperature-controlled using the loop 302, 402.

It is most useful when all of the hot and cold sources of the propulsion unit are connected by the loop 302, 402.

It is also possible to integrate, into the loop 302, 402, the cooling of the oil of the electrical generators, which in current configurations is cooled by a compact exchanger or a surface exchanger whose cold source is the air of the fan flow, possibly combined with compact exchangers placed on the engine oil and/or fuel circuits.

It is also possible to use this same loop to control the temperature of the hydraulic fluid by adding an exchanger between the hydraulic fluid and the heat transfer fluid of the fluid loop.

The loop can also be used to provide temperature control of the (low-pressure and high-pressure) casings of the set of turbines, by routing the main line 306, 406 around the casings.

Systems such as the air bleed valves can also be temperature-controlled using the loop. It is most useful when all of the hot and cold sources of the propulsion unit are connected by the fluid loop.

An embodiment of the invention is dual-flow turbomachine (30, 40) for an aircraft (200), comprising a nacelle (11) forming an air inlet lip, a set of compressors (14), a combustion chamber (16), a set of turbines (18), a supply line (55) supplying fuel to the combustion chamber (16), a transfer line (56) which circulates oil from the set of compressors (14) to the set of turbines (18), a de-icing circuit (310, 410) for the air inlet lip, and a heat management system (300, 400) comprising: a first heat exchanger (51) providing an exchange of heat between the fuel in the supply line (55) and the oil in the transfer line (56), a loop (302, 402) comprising a main line (306, 406) and a pump (304, 404) which is designed to circulate a heat transfer fluid in the main line (306, 406), where the main line (306, 406) is connected to the outlet of the pump (304, 404) and enters an inlet of a third heat exchanger (308, 408), where at the outlet of the third heat exchanger (308, 408) the main line (306, 406) meets an inlet of the de-icing circuit (310, 410), where at the outlet of the de-icing circuit (310, 410) the main line (306, 406) meets the inlet of the pump (304, 404), and where the third heat exchanger (308, 408) provides an exchange of heat between the heat transfer fluid of the main line (306, 406) and the oil of the transfer line (56) leaving the first heat exchanger (51).

The heat management system (300, 400) comprises: a first three-way valve (352, 452) arranged upstream of the inlet of the third heat exchanger (308, 408) and a first divert line (353, 453) arranged between the first valve (352, 452) and the main line (306, 406), downstream of the outlet of the third heat exchanger (308, 408), and/or a second three-way valve (354, 454) arranged upstream of the inlet to the de-icing circuit (310, 410) and a second divert line (355, 455) arranged between the second valve (354, 454) and the main line (306, 406), downstream of the outlet of the de-icing circuit (310, 410).

The heat management system (300, 400) may comprise a fourth heat exchanger (312, 412) arranged on the main line (306, 406) between the outlet of the de-icing circuit (310, 410) and the inlet of the pump (304, 404), and in that the fourth heat exchanger (312, 412) provides an exchange of heat between the heat transfer fluid in the main line (306, 406) and the air of a first air line (314, 414) which takes air from the secondary flow of the turbomachine (30, 40) and discharges it to the outside or to the secondary flow.

The heat management system (300, 400) may comprise a third three-way valve (356, 456) arranged upstream of the inlet of the fourth heat exchanger (312, 412) and a third divert line (357, 457) arranged between the third valve (356, 456) and the main line (306, 406), downstream of the outlet of the fourth heat exchanger (312, 412).

The heat management system (400) may comprise an air-conditioning system (58) which takes air from the primary flow of the set of compressors (14), via a first (59) and a second (60) line which supply an air-conditioning system of the aircraft, a second heat exchanger (52) providing an exchange of heat between, on one hand, the air of the first line (59) and the second line (60) and, on the other hand, the heat transfer fluid of the main line (406), and in that the second heat exchanger (52) is arranged on the main line (406) between the outlet of the third heat exchanger (408) and the inlet of the de-icing circuit (410).

The heat management system (400) may comprise a fourth three-way valve (458) arranged upstream of the inlet of the second heat exchanger (52) and a fourth divert line (459) arranged between the fourth valve (458) and the main line (406), downstream of the outlet of the second heat exchanger (52).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A dual-flow turbomachine for an aircraft comprising:
a nacelle forming an air inlet lip,
a set of compressors,
a combustion chamber,
a set of turbines,
a supply line configured to supply fuel to the combustion chamber,
a transfer line configured to circulate oil from the set of compressors to the set of turbines,
a de-icing circuit for the air inlet lip, and
a heat management system comprising:
a first heat exchanger providing an exchange of heat between the fuel in the supply line and the oil in the transfer line,
a loop comprising a main line and a pump which is designed to circulate a heat transfer fluid in the main line, where the main line is connected to the outlet of the pump and enters an inlet of a third heat exchanger, where at the outlet of the third heat exchanger the main line meets an inlet of the de-icing circuit, where at the outlet of the de-icing circuit the main line meets the inlet of the pump, and where the third heat exchanger provides an exchange of heat between the heat transfer fluid of the main line and the oil of the transfer line leaving the first heat exchanger.

2. The turbomachine according to claim 1, wherein the heat management system comprises:
a first three-way valve arranged upstream of the inlet of the third heat exchanger and a first divert line arranged between the first valve and the main line, downstream of the outlet of the third heat exchanger, and/or
a second three-way valve arranged upstream of the inlet to the de-icing circuit and a second divert line arranged between the second valve and the main line, downstream of the outlet of the de-icing circuit.

3. The turbomachine according to claim 1, wherein the heat management system comprises a fourth heat exchanger arranged on the main line between the outlet of the de-icing circuit and the inlet of the pump, and in that the fourth heat exchanger provides an exchange of heat between the heat transfer fluid in the main line and the air of a first air line which takes air from the secondary flow of the turbomachine and discharges it to the outside or to the secondary flow.

4. The turbomachine according to claim 3, wherein the heat management system comprises a third three-way valve arranged upstream of the inlet of the fourth heat exchanger and a third divert line arranged between the third valve and the main line, downstream of the outlet of the fourth heat exchanger.

5. The turbomachine according to claim 1, wherein the heat management system comprises an air-conditioning system configured to duct air from the primary flow of the set of compressors, via a first and a second line which supply an air-conditioning system of the aircraft, a second heat exchanger providing an exchange of heat between, on one hand, the air of the first line and the second line and, on the other hand, the heat transfer fluid of the main line, and in that the second heat exchanger is arranged on the main line between the outlet of the third heat exchanger and the inlet of the de-icing circuit.

6. The turbomachine according to claim 5, wherein the heat management system comprises a fourth three-way valve arranged upstream of the inlet of the second heat exchanger and a fourth divert line arranged between the fourth valve and the main line, downstream of the outlet of the second heat exchanger.

7. An aircraft comprising the turbomachine according to claim 1.

8. An engine assembly for an aircraft comprising:
a gas turbine engine including a compressor, combustion chamber, turbine, a fuel supply line configured to supply fuel to the combustion chamber, and a transfer line configured to circulate oil through the gas turbine engine;
a nacelle housing the gas turbine engine, wherein the nacelle includes an air inlet lip; and
a heat management system comprising:
a main line fluid passage including a de-icing fluid passage adjacent the air inlet lip;
a pump coupled to the main line fluid passage and configured to move de-icing fluid through the main line fluid passage, and
a heat exchanger coupled to the main line fluid passage and to the transfer line, wherein the heat exchanger is configured to transfer heat from the oil flowing through the transfer line to the de-icing fluid flowing through the main line fluid passage.

9. The engine assembly of claim 8 wherein the main line fluid passage is a closed loop passage which circulates the de-icing fluid through the de-icing fluid passage, the pump and the heat exchanger.

10. The engine assembly of claim 8 wherein the heat exchanger is upstream in the main line fluid passage to the de-icing fluid passage and downstream of the pump.

11. The engine assembly of claim 8 wherein the heat management system further comprises:
a first three-way valve arranged upstream of the heat exchanger and a first diverter line having an inlet coupled to the main line fluid passage upstream of the heat exchanger and an outlet coupled to the main line fluid passage downstream of the heat exchanger, wherein the first three-way valve is configured to selectively direct the de-icing fluid through the heat exchanger or the first diverter line, and/or
a second three-way valve arranged upstream of the de-icing fluid passage and a second diverter line having an inlet coupled to the main line fluid passage upstream of the de-icing fluid passage and an outlet coupled to the main line fluid passage downstream of the de-icing fluid passage, wherein the second three-way valve is configured to selectively direct the de-icing fluid through the de-icing fluid passage or the second diverter line.

12. The engine assembly of claim 8, wherein the heat management system comprises another heat exchanger coupled to the main line fluid passage and configured to transfer heat from the de-icing fluid to an air stream flowing from a fan driven by the gas turbine.

13. The engine assembly of claim 12, wherein the heat management system further comprises:
a third three-way valve coupled to the main line fluid passage upstream of the another exchanger, and
a third diverter line having an inlet coupled to the main line fluid passage upstream of the another heat exchanger and downstream of the third three-way valve, and an outlet coupled to the main line fluid passage downstream of the another heat exchanger.

14. The engine assembly of claim 8, wherein the heat management system further comprises another heat exchanger coupled to the main line fluid passage and to a compressed air passage having an inlet coupled to the compressor, wherein the another heat exchanger is configured to transfer heat from compressed air ducted from the compressor and flowing through the compressed air passage to the de-icing fluid flowing through the main line fluid passage.

15. The engine assembly of claim 14 further comprising:
another three-way valve coupled to the main line fluid passage upstream of the another exchanger, and
another diverter line having an inlet coupled to the main line fluid passage upstream of the another exchanger and downstream of the third three-way valve, and an outlet coupled to the main line fluid passage downstream of the another heat exchanger.

16. The engine assembly of claim 8 wherein the main line fluid passage is configured for a liquid de-icing fluid.
